(19) United States
(12) Patent Application Publication
(10) Pub. No.: US 2011/0199054 A1
(43) Pub. Date: Aug. 18, 2011

(54) METHODS FOR CHARGING METAL-AIR CELLS

(75) Inventors: Trygve Burchardt, Mannedorf (CH); Romuald Franklin Ngamga, Mannedorf (CH)

(73) Assignee: ReVolt Technology Ltd.

(21) Appl. No.: 13/026,115

(22) Filed: Feb. 11, 2011

Related U.S. Application Data
(60) Provisional application No. 61/304,287, filed on Feb. 12, 2010.

(51) Int. Cl. H02J 7/00

(52) U.S. Cl. 320/139

(57) ABSTRACT

A method of charging a metal-air battery is provided. The method of charging a metal-air battery includes charging the metal-air battery using a charge profile. The method further includes applying a pulse charge to the metal-air battery. The method further includes returning to charging the metal-air battery using the charge profile after the pulse charge has been applied.

### CROSS-REFERENCE TO RELATED PATENT APPLICATIONS

The present application claims priority to and the benefit of U.S. Provisional Patent Application No. 61/304,287, filed Feb. 12, 2010, the entire disclosure of which is incorporated herein by reference.

### BACKGROUND

The present application relates generally to the field of batteries. More specifically, the present application relates to methods for charging rechargeable metal-air batteries or cells (e.g., a zinc-air battery) to reduce degradation of the battery. The concepts disclosed herein are further applicable to metal-air fuel cells.

Metal-air batteries or cells (e.g., zinc-air batteries) include a negative metal (e.g., zinc) electrode and a positive electrode having a porous structure with catalytic properties for an oxygen reaction. An alkaline electrolyte is used to maintain high ionic conductivity between the two electrodes. For alkaline metal-air batteries, the air electrode is usually made from thin porous polymeric material (e.g., polytetrafluoroethylene) bonded carbon layers. To prevent a short circuit of the battery, a separator is provided between the anode and the cathode.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials are used). Since the technology uses materials and processes that are readily available in the U.S. and elsewhere, dependence on scarce resources such as oil may be reduced.

On discharging metal-air batteries, oxygen from the atmosphere is converted to hydroxyl ions in the air electrode. The hydroxyl ions then migrate to the metal electrode, where they cause the metal (e.g., zinc) contained in metal electrode to oxidize. The desired reaction in the air electrode of a metal-air battery involves the reduction of oxygen, the consumption of electrons, and the production of hydroxyl ions. The hydroxyl ions migrate through the electrolyte towards the metal electrode, where oxidation of the metal occurs, forming oxides and liberating electrons. In a secondary (i.e., rechargeable) metal-air battery, charging converts hydroxyl ions to oxygen in the air electrode, releasing electrons. At the metal electrode, the metal oxides or ions (e.g., zinc oxides or ions) are reduced to form the metal (e.g., zinc) while electrons are consumed.

Primary (i.e., non-rechargeable, single-use) metal-air batteries are well described in literature and are commercially available. Current applications include hearing aids and some military applications. Metal electrodes such as zinc electrodes have been described in numerous papers and patents in the context of alkaline batteries such as MnO2/Zn, Ag/Zn and Ni/Zn batteries. The air electrode, in addition to the use in metal-air batteries, has also been studied for the use in alkaline fuel cells.

Several attempts to make secondary (i.e., rechargeable or refillable) metal-air batteries have been described in various publications. For example, the literature describes the use of a refill solution that uses Zn slurry, pellets, or plates that are filled into the battery, and after or during discharge, the formed ZnO is removed from the battery.

Past attempts at making secondary metal-air batteries have suffered from several issues. For example, the batteries may degrade and show a slow loss in the capacity or a decrease in the discharge voltage over cycle numbers. It is believed that the loss of capacity is related to the metal electrode and the decrease in the discharge voltage is related to the air electrode.

The main degradation mechanisms for the metal electrode appear to be related to chemical reactions, such as hydrogen formation and metal/metal oxide precipitation, causing loss in electronic and ionic conductivity, low charge efficiency, and short circuit. The main degradation mechanisms for the air electrode appear to be chemical side reactions that cause dissolution of materials or flooding and gas (e.g., oxygen) entrapment during charging.

Several methods relating to how to reduce, eliminate, or slow down these degradation mechanisms have been described in literature. It does not appear, however, that methods of charging the batteries to improve the rechargeable properties have been proposed.

Accordingly, it would be advantageous to provide a charging scheme or process for reducing potentially adverse effects that may affect secondary metal-air batteries over the life of such batteries. Because degradation of a metal-air battery can have an adverse affect on the capacity and/or discharge voltage of the battery, it is desirable to provide solutions for reducing degradation of a metal-air battery.

### SUMMARY

An exemplary embodiment relates to a method of charging a metal-air battery. The method includes charging the metal-air battery using a charge profile. The method further includes applying a pulse charge to the metal-air battery. The method further includes returning to charging the metal-air battery using the charge profile after the pulse charge has been applied.

In some embodiments, applying the pulse charge may include detecting that a pulse time of the pulse charge has exceeded a minimum pulse time threshold and stopping the pulse charge after the pulse time has exceeded the minimum pulse time threshold and before the pulse time exceeds a maximum pulse time threshold.

In some embodiments, charging the metal-air battery using a charge profile may include charging the metal-air battery at a first voltage and applying the pulse charge may include charging the metal-air battery at a second voltage that is higher than the first voltage.

In some embodiments, charging the metal-air battery using a charge profile may include charging the metal-air battery at a first current and applying the pulse charge may include charging the metal-air battery at a second current that is higher than the first current.

In some embodiments, charging the metal-air battery using a charge profile may include charging the metal-air battery at a first current and applying the pulse charge may include charging the metal-air battery at a second current that is lower than the first current.

In some embodiments, charging the metal-air battery using a charge profile may include charging the metal-air battery at a first current having a first direction and wherein applying the pulse charge may include charging the metal-air battery at a second current having a second direction that is opposite the first direction.

In some embodiments, the charging, applying and returning operations may be performed in a single charge cycle having a cycle duration. A first portion of the cycle duration in which the pulse charge is applied may be substantially shorter in duration than a second portion of the cycle duration in which the metal-air battery is charged using the charge profile. In some embodiments, a plurality of pulse charges may be applied during the single charge cycle and a total duration of the plurality of pulse charges may be substantially shorter in duration than the second portion of the cycle duration in which the metal-air battery is charged using the charge profile.

In some embodiments, applying a pulse charge may include, while charging a metal-air battery, detecting damage to the metal-air battery by detecting a variation in at least one of a rate of change of a voltage of the metal-air battery or a rate of change of a current of a metal-air battery before a charge capacity of the metal-air battery is reached and applying the pulse charge to the metal-air battery in response to detecting the damage.

Another exemplary embodiment relates to a an apparatus for charging a metal-air battery. The apparatus comprises a battery charger configured to charge the metal-air battery. The battery charger is configured to charge the metal-air battery using a charge profile. The battery charger is further configured to apply a pulse charge to the metal-air battery. The battery charger is further configured to return to charging the metal-air battery using the charge profile after the pulse charge has been applied.

In some embodiments, the battery charger may be configured to apply the pulse charge by detecting that a pulse time of the pulse charge has exceeded a minimum pulse time threshold and stopping the pulse charge after the pulse time has exceeded the minimum pulse time threshold and before the pulse time exceeds a maximum pulse time threshold.

In some embodiments, the battery charger may be configured to charge the metal-air battery using the charge profile at a first voltage and apply the pulse charge at a second current that is higher than the first voltage.

In some embodiments, the battery charger may be configured to charge the metal-air battery using the charge profile at a first current and apply the pulse charge at a second current that is higher than the first current.

In some embodiments, the battery charger may be configured to charge the metal-air battery using the charge profile at a first current and apply the pulse charge at a second current that is lower than the first current.

In some embodiments, the battery charger may be configured to charge the metal-air battery using the charge profile at a first current having a first direction and apply the pulse charge at a second current having a second direction that is opposite the first direction.

In some embodiments, the battery charger may be configured to perform the charging, applying and returning operations in a single charge cycle having a cycle duration. A first portion of the cycle duration in which the pulse charge is applied may be substantially shorter in duration than a second portion of the cycle duration in which the metal-air battery is charged using the charge profile. In some embodiments, the battery charger may be configured to apply a plurality of pulse charges during the single charge cycle and a total duration of the plurality of pulse charges may be substantially shorter in duration than the second portion of the cycle duration in which the metal-air battery is charged using the charge profile.

In some embodiments, the battery charger may be configured to, while charging the metal-air battery, detect damage to the metal-air battery by detecting a variation in at least one of a rate of change of a voltage of the metal-air battery or a rate of change of a current of a metal-air battery before a charge capacity of the metal-air battery is reached and apply the pulse charge to the metal-air battery in response to detecting the damage.

Another exemplary embodiment relates to a method of charging a metal-air battery. The method comprises, while charging a metal-air battery using a charge profile, detecting damage to the metal-air battery by detecting a variation in at least one of a rate of change of a voltage of the metal-air battery or a rate of change of a current of a metal-air battery before a charge capacity of the metal-air battery is reached. The method further comprises applying a pulse charge to the metal-air battery to reduce the damage.

In some embodiments, detecting damage to the metal-air battery may include detecting a short in the metal-air battery by identifying a drop in voltage while charging using a constant current. The pulse charge may be applied to remove the short.

In some embodiments, charging the metal-air battery may include charging the metal-air battery at a first voltage and applying the pulse charge may include charging the metal-air battery at a second voltage that is higher than the first voltage.

In some embodiments, charging the metal-air battery may include charging the metal-air battery at a first current and applying the pulse charge may include charging the metal-air battery at a second current that is higher than the first current.

In some embodiments, charging the metal-air battery may include charging the metal-air battery at a first current and applying the pulse charge may include charging the metal-air battery at a second current that is lower than the first current.

In some embodiments, charging the metal-air battery may include charging the metal-air battery at a first current having a first direction and applying the pulse charge may include charging the metal-air battery at a second current having a second direction that is opposite the first direction.

In some embodiments, the charging, detecting and applying operations may be performed in a single charge cycle having a cycle duration. A first portion of the cycle duration in which the pulse charge is applied may be substantially shorter in duration than a second portion of the cycle duration in which the metal-air battery is charged using the charge profile. In some embodiments, a plurality of pulse charges may be applied during the single charge cycle and a total duration of the plurality of pulse charges may be substantially shorter in duration than the second portion of the cycle duration in which the metal-air battery is charged using the charge profile.

In some embodiments, applying the pulse charge may include detecting that a pulse time of the pulse charge has exceeded a minimum pulse time threshold and stopping the pulse charge after the pulse time has exceeded the minimum pulse time threshold and before the pulse time exceeds a maximum pulse time threshold.

In various embodiments, the minimum pulse time threshold may be 1 second and the maximum pulse time threshold may be 60 seconds.

In various embodiments, the pulse charge may be a voltage pulse charge. A voltage of the voltage pulse charge may be less than 2.2 V. In various embodiments, the pulse charge may be a current pulse charge. A current of the current pulse charge may be less than 200 mA/cm².

### BRIEF DESCRIPTION OF THE DRAWINGS

FIG. 1 is a perspective view of a metal-air battery in the form of a button cell according to an exemplary embodiment.

FIG. 2 is a cross-sectional view of the metal-air battery shown in FIG. 1 taken along a line 2-2.

FIG. 3A is a flow diagram of a process of charging a metal-air battery according to an exemplary embodiment.

FIG. 3B is a flow diagram of another process of charging a metal-air battery according to an exemplary embodiment.

FIG. 4A is a more detailed flow diagram of the process of charging a metal-air battery shown in FIG. 3 according to an exemplary embodiment.

FIG. 4B is a more detailed flow diagram of the process of charging a metal-air battery shown in FIG. 3B according to an exemplary embodiment.

FIGS. 5 through 9 are flow diagrams of processes of charging a metal-air battery according to various exemplary embodiments.

FIGS. 10A through 10H are illustrations of electrodes of a metal-air battery after applying a series of discharge pulses during pulse charging.

FIGS. 11A through 11G are graphs illustrating charging profiles of a metal-air battery according to various exemplary embodiments.

### DETAILED DESCRIPTION

According to various exemplary embodiments, methods of charging a metal-air battery or cell are described that are intended to reduce degradation of the battery or cell. In various exemplary embodiments, methods of charging a metal-air battery may be based on voltage, current, rate of change of potential energy or voltage, rate of change of current, Coulomb count or capacity, impedance, temperature, etc.

The metal-air battery may have any desired configuration, including, but not limited to, button or coin cells, prismatic cells, cylindrical cells, flow cells, fuels cells, etc. Further, the metal-air battery may be a primary (disposable, single-use) battery or a secondary (rechargeable) battery.

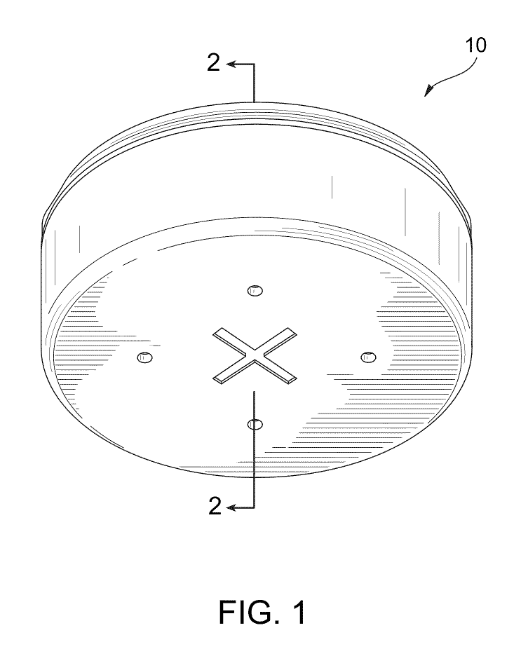

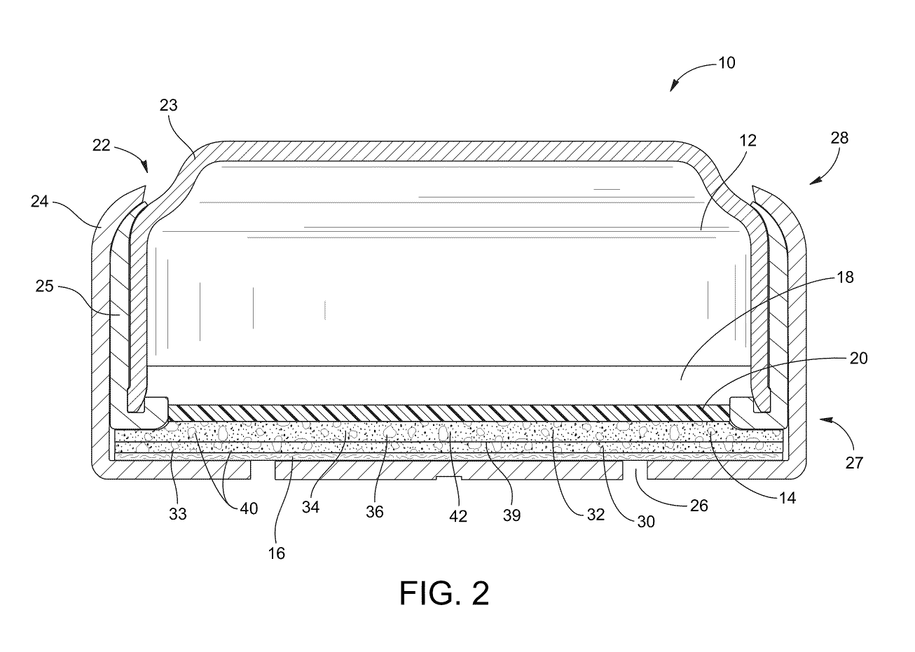

Referring to FIGS. 1-2, a metal-air battery 10 shown as a coin or button cell is illustrated according to an exemplary embodiment.

Referring to FIG. 2, the battery 10 includes a metal electrode 12, an air electrode 14 including a gas diffusion layer 30 and an active layer 32 (the active layer possibly also including an oxygen evolution layer), an electrolyte 18, a separator 20, an oxygen distribution layer 16 (e.g., a non-woven fibrous material intended to distribute oxygen entering the system evenly throughout the air electrode 14), and an enclosing structure shown as a housing 22 according to an exemplary embodiment.

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “AB_{X}” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown including a base 23 and a lid 24 according to an exemplary embodiment. A seal 25 (e.g., a molded nylon sealing gasket, etc.) is formed/disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 at a first portion 27 of the housing 22 generally opposite a second portion 28. The metal electrode 12 is shown disposed within housing 22 at or proximate to the second portion 28. The air electrode 14 is shown disposed at or proximate to the first portion 27, and spaced a distance from the metal electrode 12. The holes 26 (e.g., apertures, openings, slots, recesses, etc.) provide for interaction between the air electrode 14 and the oxygen in the surrounding atmosphere (e.g., air), with the oxygen distribution layer 16 allowing for relatively even distribution of the oxygen to the air electrode 14. The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The separator 20 is a thin, porous, film or membrane formed of a polymeric material and disposed substantially between the metal electrode 12 and the air electrode 14 according to an exemplary embodiment. The separator 20 is configured to prevent short circuiting of the battery 10. In some exemplary embodiments, the separator 20 includes or is made of polypropylene or polyethylene that has been treated to develop hydrophilic pores that are configured to fill with the electrolyte 18. In other exemplary embodiments, the separator may be made of any material configured to prevent short circuiting of the battery 10 and/or that includes hydrophilic pores.

The electrolyte 18 is shown disposed substantially between the metal electrode 12 and the air electrode 14 according to an exemplary embodiment. The electrolyte 18 (e.g., potassium hydroxide (“KOH”) or other hydroxyl ion-conducting media) is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge. The electrolyte 18 is disposed within some of the pores of the metal electrode 12 and some of the pores of the air electrode 14. According to other exemplary embodiments, the distribution and location of the electrolyte may vary (e.g., the electrolyte may be disposed in the pores of the metal electrode and to a lesser degree within the pores of the air electrode, etc.).

According to an exemplary embodiment, the electrolyte 18 may optionally include an ionic liquid. The electrolyte 18 is configured to be relatively highly ionically conductive to provide for high reaction rates for the oxygen reduction/evolution and the metal oxidation/reduction reactions. High reaction rates help the battery 10 achieve a desired current density. The electrolyte 18 is further configured to have a relatively low vapor pressure point. The low vapor pressure point means that the electrolyte 18 has a relatively low evaporation rate, which helps to prevent (e.g., resist, slow, etc.) drying out of the electrolyte 18. By preventing the drying out of the electrolyte 18, increased ohmic resistance is avoided. Increased ohmic resistance in a battery generally results in a loss in the power density and a decrease in the efficiency of the battery. The electrolyte 18 may further be configured to stabilize the three phase boundary within the air electrode. The electrolyte 18 may further be configured to provide for more uniform depositions and a different reaction mechanism due to its effect on the charge and discharge reactions (e.g., improving the discharge properties of the battery). According to one exemplary embodiment, the ionic liquid of the electrolyte 18 may be further tailored to provide for low solubility of CO₂ (e.g., by combining the electrolyte with other materials and/or additives, etc.). In some exemplary embodiments, the ionic liquids are configured to be stable and/or be soluble in OH⁻ solutions. In some exemplary embodiments, the ionic liquids are configured to dissolve oxygen. In some exemplary embodiments, the ionic liquids are hydroscopic and can take water from the environment.

According to an exemplary embodiment, the electrolyte 18 is an alkaline electrolyte used to maintain high ionic conductivity between the metal electrode and the air electrode. According to other exemplary embodiments, the electrolyte may be any electrolyte that has high ionic conductivity and/or high reaction rates for the oxygen reduction/evolution and the metal oxidation/reduction (e.g., NaOH, LiOH, etc.). According to still other embodiments, the electrolyte may include salt water or others salt-based solutions that give sufficient conductivity for the targeted applications (e.g., for marine/military applications, etc.).

According to an exemplary embodiment, the metal electrode and the electrolyte are combined (e.g., mixed, stirred, etc.). The combination of the metal electrode and the electrolyte may form a paste, powder, pellets, slurry, etc.

The air electrode 14 includes one or more layers with different properties and a current collector 39 (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the housing 22. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. Further, other layers may be included in/on or coupled to the air electrode, such as a gas selective membrane.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

In the exemplary embodiment shown, the air electrode 14 further includes a binding agent or combination of binding agents 40, a catalyst or a combination of catalysts 42, and/or other additives (e.g., ceramic materials, high surface area metals or alloys stable in alkaline media, etc.). The binding agents 40 are shown included in both the active layer 32 and the gas diffusion layer 30. The catalysts 42 are shown included in the active layer 32. In other exemplary embodiments, the binding agents, the catalysts, and/or the other additives may be included in any, none, or all of the layers of the air electrode. In other exemplary embodiments the air electrode may not contain one or more of a binding agent or combinations of binding agents, a catalyst or a combination of catalysts, and/or other additives.

The binding agents 40 provide for increased mechanical strength of air electrode 14, while providing for maintenance of relatively high diffusion rates of oxygen (e.g., comparable to more traditional air electrodes that typically use polytetrafluoroethylene (“PTFE”)). The binding agents 40 may also cause pores in the air electrode 14 to become hydrophobic. According to one exemplary embodiment, the binders include PTFE in combination with other binders. According to other exemplary embodiments, other polymeric materials may also be used (e.g., polyethylene (“PE”), polypropylene (“PP”), thermoplastics such as polybutylene terephthalate or polyamides, polyvinylidene fluoride, silicone-based elastomers such as polydimethylsiloxane, or rubber materials such as ethylene propylene, and/or combinations thereof).

According to an exemplary embodiment, the binding agents 40 provide mechanical strength sufficient to allow the air electrode 14 to be formed in a number of manners, including, but not limited to, one or a combination of extrusion, stamping, pressing, utilizing hot plates, calendering, etc.

The inventors have unexpectedly determined that, when used as binding agents, PE and PP provide improved mechanical strength of the air electrode. This improved mechanical strength also facilitates formation of the air electrode 14 into any of a variety of shapes (e.g., a tubular shape, a shape to accommodate or correspond to the shape of a housing, etc.). The ability to form the air electrode into any of a variety of shapes may allow for the use of metal-air batteries in applications such as Bluetooth headsets, digital cameras, and other applications for which cylindrical batteries are used or required (e.g., size AA batteries, size AAA batteries, size D batteries), etc. More generally, the use of PE and/or PP also allows for improved/new electrode formation methods, shapes, and applications for metal-air batteries as discussed in more detail below. According to other exemplary embodiments, any plastic material having a melting point lower than PTFE (e.g., below 350° C.) may provide benefits similar to those of PE and PP when used as a binding agent.

The catalysts 42 are configured to improve the reaction rate of the oxygen reaction. According to some exemplary embodiments, catalytically active metals or oxygen-containing metal salts are used (e.g., Pt, Pd, Ag, Co, Fe, MnO₂, KMnO₄, MnSO₄, SnO₂, Fe₂O₃, CoO, CO₃O₄, etc.). According to other exemplary embodiments, a combination of more than one catalytically active material may be used. According to some exemplary embodiments, the catalysts 42 may include recombination catalysts, which the inventors have unexpectedly determined have desirable hydrogen consuming/inhibiting abilities.

In an exemplary embodiment, the battery 10 is a secondary battery (e.g., rechargeable) and the air electrode 14 is a bifunctional air electrode. In this embodiment, additional catalysts or catalyst combinations capable of evolving oxygen may be used in addition to the catalysts and/or combinations of catalysts described above. According to some exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, the battery 10 may be a primary battery (e.g., single use, disposable, etc.).

Referring further to FIG. 2, the current collector 39 is disposed between the gas diffusion layer 30 and the active layer 32 of the air electrode 14 according to an exemplary embodiment. According to another exemplary embodiment, the current collector may be disposed on the active layer (e.g., when a non-conductive layer or no gas diffusion layer is included in the air electrode). The current collector 39 may be formed of any suitable electrically-conductive material.

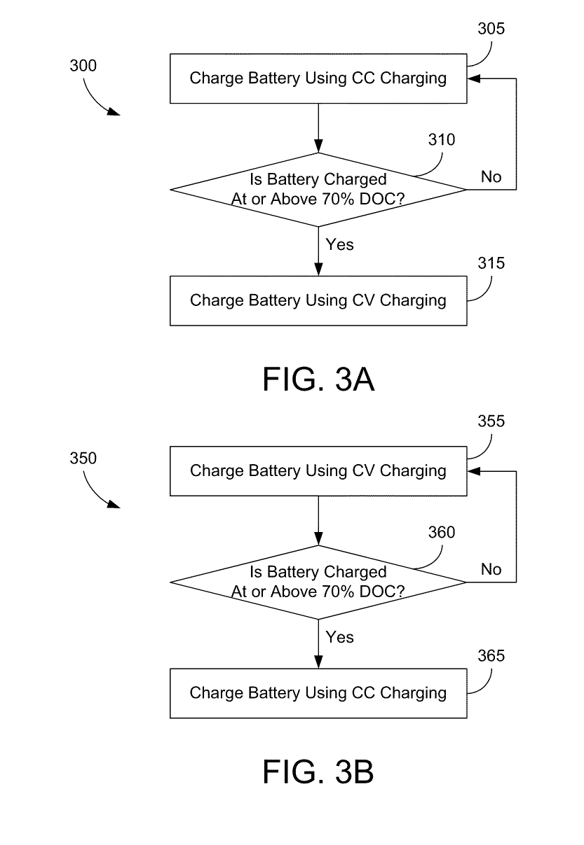

Referring generally to FIGS. 3-9, various charging methods and techniques for charging metal-air batteries are described according to various exemplary embodiments. In various embodiments, the charging methods described below may be used, separately or in combination, to effectively charge metal-air batteries and/or to extend the life of metal-air batteries.

Numerous patents and publications describe charging algorithms and charge electronics for rechargeable lead-acid, lithium-ion, nickel-metal-hydride (NiMH), nickel cadmium, and other types of rechargeable batteries.

A rechargeable metal-air battery differs from lead-acid, lithium-ion, nickel-metal-hydride (NiMH), nickel cadmium, and other types of rechargeable batteries, because zinc-air batteries interact with the environment by using oxygen as the cathode reactant during discharge and venting oxygen out of the battery during charging. As a result, zinc-air batteries may be more sensitive to the charging profile used to recharge the battery. Accordingly, charging control devices and/or algorithms may be useful to reduce damage or degradation to the battery due to improper or non-optimized charging. If charging control does not allow for sufficient release of gas entrapment (e.g., insufficient venting of oxygen during charging), dry out of the battery and dendrite formation (e.g., needle-like zinc crystals that may penetrate the cell separator and cause a short circuit of the battery) may cause partial or complete failure of the battery (e.g., loss of capacity, decrease in discharge voltage, etc.).

Prior attempts at charging secondary zinc-air batteries have tended to focus on managing the cutoff voltage during charging to maintain the voltage of the battery below a predefined limit to avoid degradation of the air electrode. It does not appear, however, that intelligent charging algorithms have been developed which take into account the zinc-air battery chemistry to assure that the correct charge profile is maintained.

According to various exemplary embodiments, zinc-air batteries (e.g., secondary or rechargeable) may be charged using any of several charging techniques, either alone or in combination through the use of intelligent control systems, as will be described in more detail below. The following briefly describes several types of charging mechanisms that will be helpful to the reader in understanding the exemplary embodiments described herein.

In constant current (“CC”) charging, a substantially constant or steady current (e.g., 1 amp (A)) may be applied to the battery. It may be advantageous to use CC charging, for example, if the charge profile for the battery is well defined. CC charging may provide relatively quick charging of a battery, but in some circumstances may increase the risk of overcharging the battery (e.g., with several cells in a battery pack) or degrading the battery due to prolonged charge/discharge cycling.

In constant voltage (“CV”) charging, a substantially constant or steady voltage (e.g., 2 volts (V)) may be applied to the battery. During CV charging, the voltage may be kept below a certain voltage threshold to prevent damage to the battery. In some embodiments, CC charging may be used in combination with CV charging (i.e., CC charging is used for one part of the charge profile and CV charging is used for another part).

Pulse charging involves the application of pulses (e.g., voltage or current pulses) to the battery. The pulses may have a controlled frequency, amplitude, rise time, pulse width, etc. In some embodiments, the pulses may be high voltage or high current pulses.

According to various exemplary embodiments, pulse charging may be utilized in various different ways. A first method of pulse charging involves increasing the current applied during a charge pulse for a defined duration before reducing the current back to the original level. The air electrode of a zinc-air battery may begin to degrade if the voltage at which the battery is charged is high for a substantial time period (e.g., greater than 2.15 V for at least one minute). This may appear as increased carbonization of the electrolyte with a carbon support material. By limiting the voltage during charging, the current density and, accordingly, the charge time are also limited. One method to allow faster charging is to increase the current for a short time period in a current pulse. This may limit the damaging effect on the air electrode while allowing the ZnO to Zn reaction to take place. Another method to allow faster charging is to increase the voltage for a short time period in a voltage pulse. In some embodiments, a combination of current pulses and voltage pulses may be used to charge the battery.

Other methods of pulse charging utilize a reduced current or zero current during a charge pulse. These methods increase the charge time of the zinc-air battery but may increase the life cycle of the air electrode. As described herein, the air electrode produces oxygen during charging that is transported out of the battery by hydrophobic channels in the air electrode. If the transport rate of oxygen is not sufficiently fast, pressure may build up in the battery. This may cause mechanical damage to the air electrode and/or oxygen gas entrapment in the battery, both of which may reduce the lifetime of the battery. A reduction in the charge current may provide time to vent oxygen out of the battery, reducing the risk of such damage and prolonging the battery lifetime.

Yet another method of pulse charging utilizes a reverse current during a charge pulse. Reversing the current may result in a more prolonged charge time than a reduced or zero current pulse charging method. Reversing the current may help control the deposition of zinc in the battery and repair the battery in the event unwanted zinc grows in the battery and increases the risk of micro shorts.

By altering the voltage or current pulse during charging, electrochemical reactions that may cause degradation in the battery can be controlled because the reaction kinetics, transport properties, and electron transfer have different time dependencies. In some embodiments, a reverse or negative pulse charge may be used to charge the battery.

In certain applications, it may be desirable to utilize battery packs that include a number of individual cells (the number of which may differ according to various exemplary embodiments). In such embodiments, charging electronics or devices may be used to monitor the state of charge and electrical and/or electrochemical conditions of each individual cell and/or the battery pack as a whole. Devices for individual charging of each cell may be used to increase the capacity and cycle number (i.e., the rated number of charging cycles a battery can undergo during its expected life).

In various embodiments, methods of charging a zinc-air battery may utilize various sensors or inputs in charging the battery. Various methods may use one or more characteristics of the battery such as voltage, current, rate of change of potential energy or voltage (“dU/dt”), rate of change of current (“di/dt”), impedance, coulomb count or capacity, temperature, and/or other battery characteristics in charging the battery. These battery characteristics may be determined using any suitable method or device. Temperature probes or sensors and gas gauging and/or venting devices, such as those known in the art, may be used to determine the status (e.g., battery temperature, oxygen flow, etc.) and/or health of the battery.

Referring now to FIG. 3A, a flow diagram of a process 300 for charging a zinc-air battery is shown according to an exemplary embodiment. The process 300 charges the battery using a combination of CC charging and CV charging, determining when to switch from CC charging to CV charging based at least in part on the depth of charge (“DOC”) of the battery. As used herein, the DOC is the ratio of the actual charge of the battery to the capacity of the battery at full charge. In various embodiments, a gas gauge (e.g., level meter) and/or other device may transmit data to the charging device, electronics in the battery, and/or to a user of the battery.

The battery is initially charged using CC charging (step 305). The CC charging may be performed within a limited voltage range. For example, in some embodiments, the voltage of the battery during CC charging may be in the range of between approximately 1.95 V and 2.05 V. The current during CC charging is determined by the form factor of the battery and the C-level determined by the loading of zinc. The C-level is a measure of the rated capacity of the battery as compared to the charge time. For example C/5 indicates that the battery is charged to its rated capacity in approximately five hours, C/2 indicates that the battery is charged to its rated capacity in approximately two hours, etc. In one exemplary embodiment, a 5 amp-hour (Ah) prismatic cell with a footprint of 62×37 millimeters (mm) at a 2 V charge may charge at a substantially constant current of 1 A, yielding a charge rate during the CC charge of C/5.

As the battery is charged using CC charging, it is determined (e.g., periodically, at one or more specified capacity levels, based on one or more inputs, etc.) whether the battery has been charged to a level at or above a DOC threshold (step 310). In some embodiments, the DOC threshold may be 70 to 80 percent. In other embodiments, the DOC threshold may be any other DOC of the battery. If the actual charge of the battery is not at or above the DOC threshold, the process 300 continues to charge the battery using CC charging (step 305). If the actual charge of the battery is at or above the DOC threshold, the process 300 may then operate to charge the battery using CV charging (step 315). The CV charging may also be performed within a limited voltage range. For example, in some embodiments, the voltage should be below 2.25 V and/or in the range of between approximately 1.95 V and 2.15 V. In some exemplary embodiments, a preferred voltage for CV charging may be 2.05 V.

Referring now to FIG. 3B, a flow diagram of a process 350 for charging a zinc-air battery is shown according to an exemplary embodiment. The process 350 begins charging the battery using CV charging and determines when to transition to CC charging based at least in part on the DOC of the battery. In some embodiments, various steps of the process 350 may utilize features discussed with respect to the process 300 of FIG. 3A.

The battery is initially charged using CC charging (step 355). As the battery is charged using CV charging, it is determined whether the battery has been charged to a level at or above a DOC threshold (step 360). In some embodiments, the DOC threshold may be 70 to 80 percent. In other embodiments, the DOC threshold may be any other DOC of the battery. If the actual charge of the battery is not at or above the DOC threshold, the process 350 continues to charge the battery using CV charging (step 355). If the actual charge of the battery is at or above the DOC threshold, the process 350 may then operate to charge the battery using CC charging (step 365).

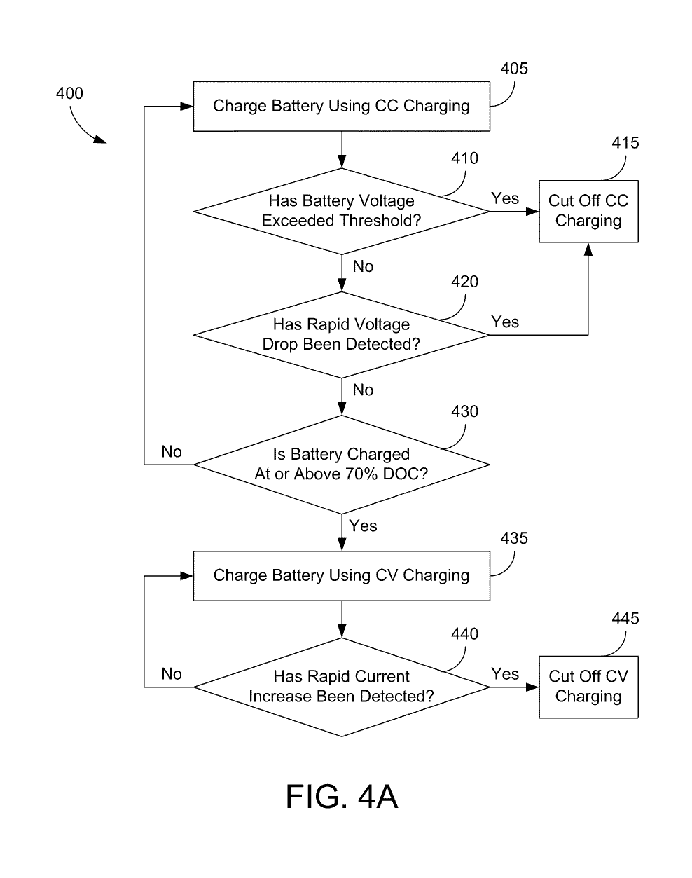

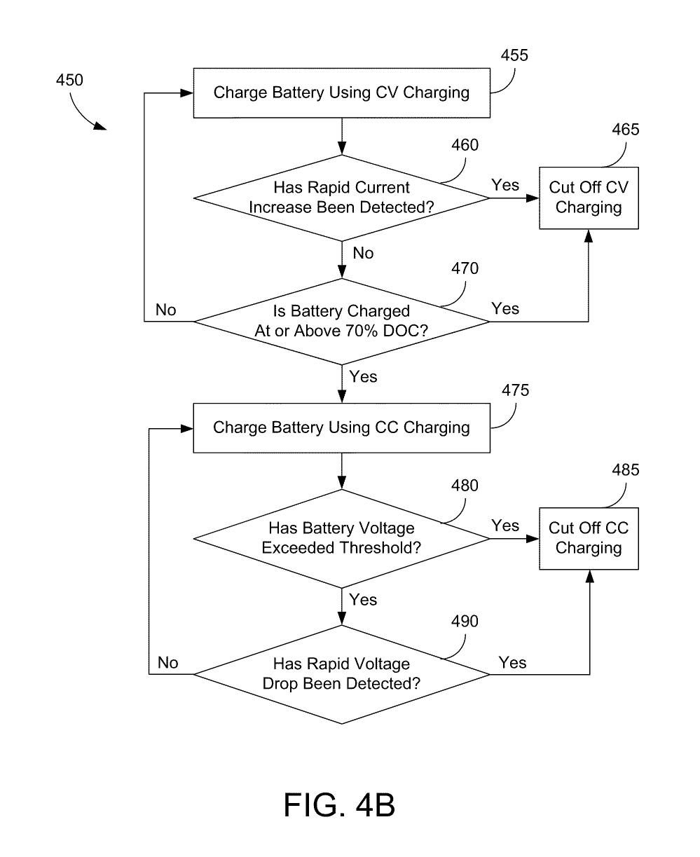

Referring now to FIG. 4A, a more detailed flow diagram of a process 400 for charging a zinc-air battery is shown according to an exemplary embodiment. The battery is initially charged using CC charging (step 405). At step 410, it is determined whether the battery voltage has exceeded a threshold voltage. In some embodiments, the threshold voltage may be a maximum voltage (e.g., 2.25 V) that the battery should not exceed for more than a specified time (e.g., 30 seconds). In other embodiments, the threshold voltage may be a maximum stable voltage (e.g., 2.15 V) that the stable voltage (e.g., the average or mean voltage over a particular time period) should not exceed. If the battery voltage has exceeded the threshold voltage, the process 400 cuts off CC charging (step 415). Throughout the present disclosure, “cutting off” a particular type or technique of charging (e.g., CC charging) may include ending charging or changing to a different type or technique of charging (e.g., CV charging).

If the battery voltage has not exceeded the threshold voltage, the process 400 determines whether a rapid voltage drop has occurred in the battery (step 420). A rapid voltage drop during CC charging may be related to micro shorts in the battery due to the zinc electrode coming in electrical contact with the air electrode (e.g., by loose particles and/or by dendrite penetration of the cell separator). In some embodiments, a rapid voltage drop may be indicated by a voltage drop of greater than 200 mV over a time period ranging from about 0.1 to 60 seconds. If a rapid voltage drop has been detected, the process 400 cuts off CC charging (step 415).

If a rapid voltage drop has not occurred, the process 400 determines whether the actual battery charge is at or above a DOC threshold (e.g., 70 to 80 percent) (step 430). If the battery charge is not above the DOC threshold, the process 400 continues to charge the battery using CC charging (step 405). If the battery charge is at or above the DOC threshold, the process 400 changes the charging type to CV charging (step 435).

Once the process 400 begins charging using CV charging, it is determined whether a rapid increase in current has occurred (step 440). Like a rapid decrease in voltage during CC charging, a rapid increase in current during CV charging may be related to micro shorts in the battery due to the zinc electrode coming in electrical contact with the air electrode. In some embodiments, a rapid current increase may be indicated by a current increase of more than 10 milliamps per square centimeter (mA/cm²) over a time period of about 0.1 to 60 seconds. If a rapid current increase has been detected, the process 400 cuts off CV charging (step 445). If a rapid increase in current has not been detected, the process 400 continues to charge the battery using CV charging (step 435).

Referring now to FIG. 4B, a more detailed flow diagram of a process 450 for charging a zinc-air battery is shown according to an exemplary embodiment. In some embodiments, various steps of the process 450 may utilize features discussed with respect to the process 400 of FIG. 4A.

The battery is initially charged using CV charging (step 455). At step 460, it is determined whether a rapid current increase has occurred in the battery (step 460). If a rapid current increase has been detected, the process 450 cuts off CV charging (step 465).

If a rapid current increase has not occurred, the process 450 determines whether the actual battery charge is at or above a DOC threshold (e.g., 70 to 80 percent) (step 470). If the battery charge is not above the DOC threshold, the process 450 continues to charge the battery using CV charging (step 455). If the battery charge is at or above the DOC threshold, the process 450 changes the charging type to CC charging (step 475).

Once the process 450 begins charging using CC charging, it is determined whether the battery voltage has exceeded a threshold voltage (step 480). If the battery voltage has exceeded the threshold voltage, the process 450 cuts off CC charging (step 485). If the battery voltage has not exceeded the threshold voltage, the process 450 determines whether a rapid voltage drop has occurred in the battery (step 490). If a rapid voltage drop has not been detected, the process 450 continues to charge the battery using CC charging (step 475). If a rapid voltage drop has been detected, the process 450 cuts off CC charging (step 485).

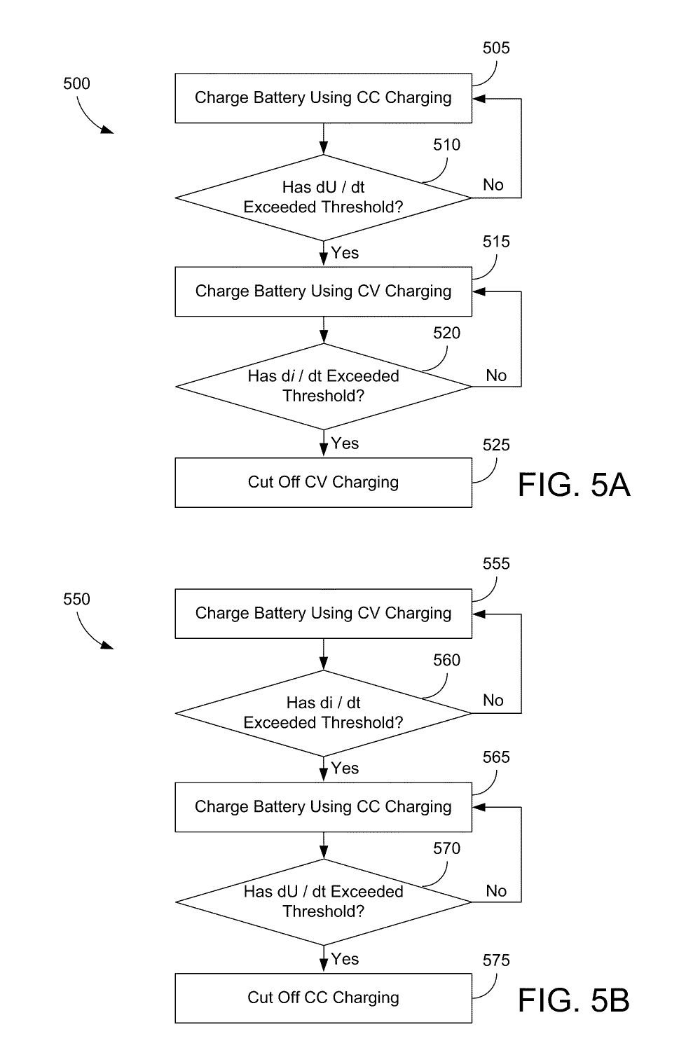

Referring now to FIG. 5A, a process 500 for charging a zinc-air battery is shown according to an exemplary embodiment. The process 500 charges the battery using CC charging and CV charging based at least in part on the rate of change of potential energy or voltage (dU/dt) and rate of change of current (di/dt) of the battery. If the battery is fully charged or cannot charge to its full capacity, a rapid increase in the voltage of the battery may result. If dU/dt exceeds a threshold level the battery may not be charged but instead a secondary hydrogen evolution reaction that may damage the battery may occur. Pressure may build up in the battery causing increased impedance, lower discharge capacity, and/or leakage of the battery.

The process 500 initially charges the battery using CC charging (step 505). At step 510, the process 500 determines if dU/dt has exceeded a threshold rate of voltage or potential change. In some embodiments, dU/dt may exceed the threshold rate of change if it is greater than 0.02 mV/sec over a time period of greater than one minute (e.g., for prismatic cell designs; for other designs, the values may differ). If dU/dt has not exceeded the threshold rate of change, the process 500 continues to charge the battery using CC charging (step 505).

If dU/dt has exceeded the threshold rate of change, the process 500 charges the battery using CV charging (step 515). At step 520, the process 500 determines if di/dt has exceeded a threshold rate of current change. As CV charging progresses, current decreases with time and tends to stabilize. The stabilization may have at least two causes: deposition of zinc at a low rate, or hydrogen evolution (possibly damaging the battery) at a high rate. A current detector may be used to measure di/dt to distinguish between these causes. In some embodiments, a di/dt rate of less than −1 mA/sec (i.e., where the current is decreasing at a rate of at least 1 mA/sec) over a time period of five minutes may indicate zinc deposition (i.e., that ZnO is being reduced to Zn). A di/dt rate of greater than −1 mA/sec (i.e., where the current is increasing or is decreasing at a rate of less than 1 mA/sec) over a time period of five minutes may indicate the occurrence of hydrogen evolution. In one embodiment, the process 500 may determine that di/dt has exceeded the threshold rate of change if di/dt is greater than −1 mA/sec over a time period of one minute, indicating that the current is increasing or stabilizing. If di/dt has not exceeded the threshold level, the process 500 continues to charge the battery using CV charging (step 515). If di/dt has exceeded the threshold level, the process 500 cuts off CV charging (step 525).

Referring now to FIG. 5B, a process 550 for charging a zinc-air battery is shown according to an exemplary embodiment. The process 550 initially charges the battery using CV charging and switches to CC charging based at least in part on the rate of change of current (di/dt) of the battery. The process 550 determines a point at which to cut off CC charging based at least in part on the rate of change of potential energy or voltage (dU/dt). In some embodiments, various steps of the process 550 may utilize features discussed with respect to the process 500 of FIG. 5A.

The process 550 initially charges the battery using CV charging (step 555). At step 560, the process 550 determines if di/dt has exceeded a threshold rate of current change. If di/dt has not exceeded the threshold level, the process 550 continues to charge the battery using CV charging (step 555).

If di/dt has exceeded the threshold level, the process 550 begins charging the battery using CC charging (step 565). At step 570, it is determined if dU/dt has exceeded a threshold rate of voltage change. If dU/dt has not exceeded the threshold level, the process 550 continues to charge the battery using CC charging (step 565). If dU/dt has exceeded the threshold level, the process 550 cuts off CC charging (step 575).

It should be appreciated that the values provided for dU/dt, di/dt, and/or other values contained in the present disclosure are exemplary values and may vary amongst differing batteries. For example, the provided values may be similar to those observed in a battery having a prismatic cell design but may vary from those observed in batteries having other designs. Further, it should be appreciated that, in various embodiments, fewer, additional, and/or different conditions than those shown in FIGS. 3A through 5B may be used to determine a point at which the charging should transition from CC charging to CV charging or from CV charging to CC charging and/or a point at which CC or CV charging should be stopped or cut off.

Under certain circumstances during CV charging, such as the occurrence of a micro short circuit, a rise in current may occur that may level off at a current and/or voltage lower than the cut off levels for the battery. In such circumstances, process 500 may cut off CV charging if di/dt is above a rate of change threshold (e.g., −1 mA/sec).

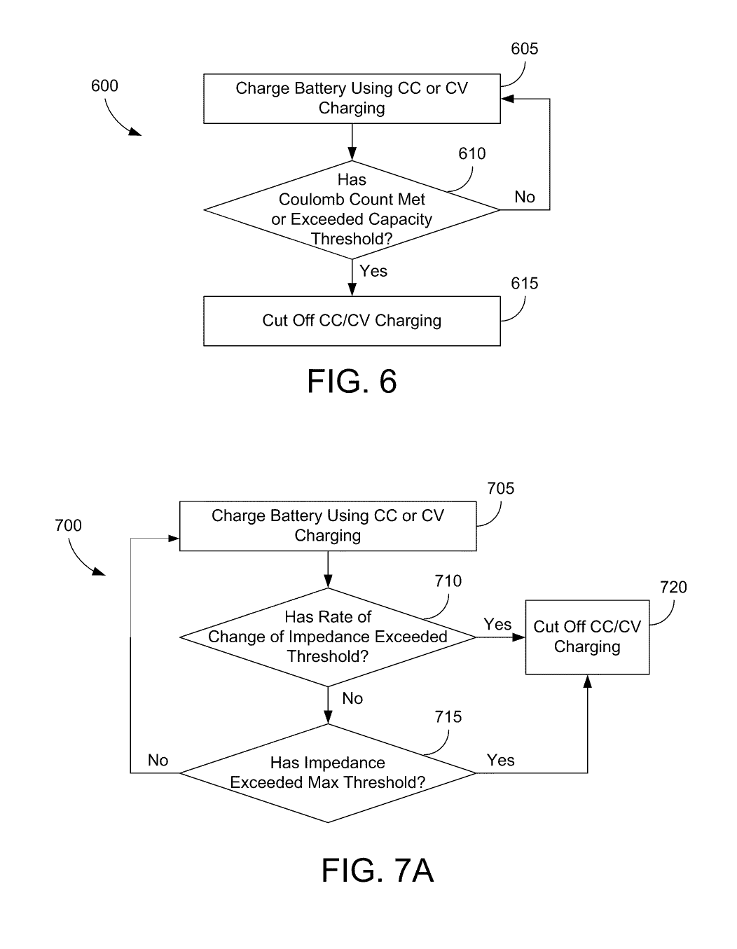

Referring now to FIG. 6, a process 600 for charging a zinc-air battery is shown according to an exemplary embodiment. The process 600 charges the battery based at least in part on a coulomb count or measurement of the charge of the battery. Charging based on a coulomb count may reduce the risk of overcharging the battery in situations where the voltage does not increase substantially when approaching the targeted capacity of the battery. Such situations may occur if the target capacity of the battery does not match the actual capacity of the system (e.g., if the battery is charged at higher temperatures causing an increase in the utilization of zinc or, in the case of a battery pack with a plurality of cells, if the cells are not well balanced). A charge or coulomb count measuring device may be integrated into the charging device or the battery electronics.

The process 600 begins by charging the battery using any charging technique (e.g., CC or CV charging) (step 605). At step 610, the process 600 determines whether the coulomb count has exceeded a capacity threshold of the battery. The capacity threshold may correspond or relate to the capacity of the battery at a full or target charge. In some embodiments, the capacity threshold may be 5 Ah. If the coulomb count has not exceeded the capacity threshold, the process 600 continues to charge the battery (step 605). If the coulomb count has exceeded the threshold, the process 600 cuts off charging (step 615).

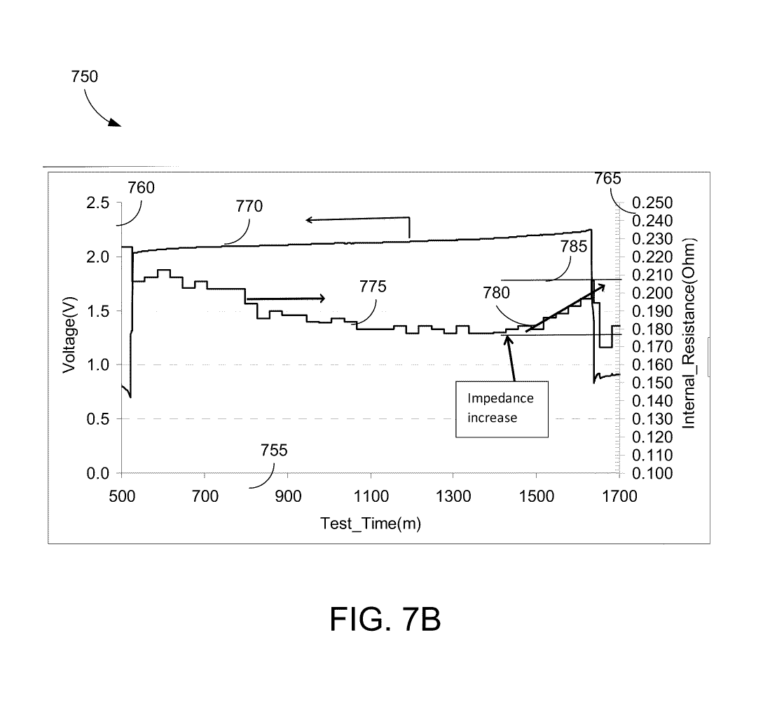

Referring now to FIG. 7A, a process 700 for charging a zinc-air battery is shown according to an exemplary embodiment. The process 700 charges the battery based at least in part on the impedance of the battery. The impedance of the battery increases during charging, and there is a direct relationship between the impedance and charge of the battery (i.e., as the charge increases, the impedance increases).

The process 700 begins by charging the battery using any charging technique (e.g., CC or CV charging) (step 705). At step 710, the process 700 determines whether the rate of change of impedance has exceeded a threshold rate of change. A rapid drop in impedance may indicate a short circuit, and a rapid increase may indicate gas formation. If the rate of change of impedance has exceeded the threshold rate of change, the process 700 cuts off charging of the battery (step 720). If the rate of change of impedance does not exceed the threshold, the process 700 determines whether the impedance has exceeded a maximum impedance threshold (step 715). If the impedance has not exceeded the threshold, the process 700 continues charging the battery (step 705). If the impedance has exceeded the threshold, the process 700 cuts off charging of the battery (step 720). In alternative embodiments, the process may perform only one of steps 710 and 715 rather than both.

Referring now to FIG. 7B, a graph 750 illustrating the operation of the process 700 in an exemplary metal-air battery (e.g., a prismatic zinc-air mobile phone size cell) is shown according to an exemplary embodiment. The graph 750 includes a horizontal test time axis 755 displaying the test time during which the battery was charged in minutes. The graph 750 also includes a vertical voltage axis 760 showing charge voltage in volts and a vertical internal resistance axis 765 showing the internal resistance or impedance of the battery in ohms. A voltage curve 770 shows the voltage at which the battery is charged over the test time with reference to the voltage axis 760. A internal resistance curve 775 shows the change in the internal resistance of the battery over the test time as the battery is charged with reference to the internal resistance axis 765.

As can be seen in the graph 750, the internal resistance and, accordingly, impedance of the exemplary battery increases over the last twenty percent DOC. In the displayed embodiment, charging is cut off (as shown by the steep drop in the voltage curve 770) when the battery reaches a maximum internal resistance 785 (e.g., 0.208 ohms) (corresponding to a maximum impedance threshold as utilized in step 715 of the process 700). Also displayed in the graph 750 is a rate of change of internal resistance curve 780 displaying the average rate of change of internal resistance between 0.178 ohms and 0.208 ohms. In another exemplary embodiment, charging may be cut off based on the rate of change of internal resistance (or rate of change of impedance) exceeding a threshold rate of change as in step 720 of the process 700.

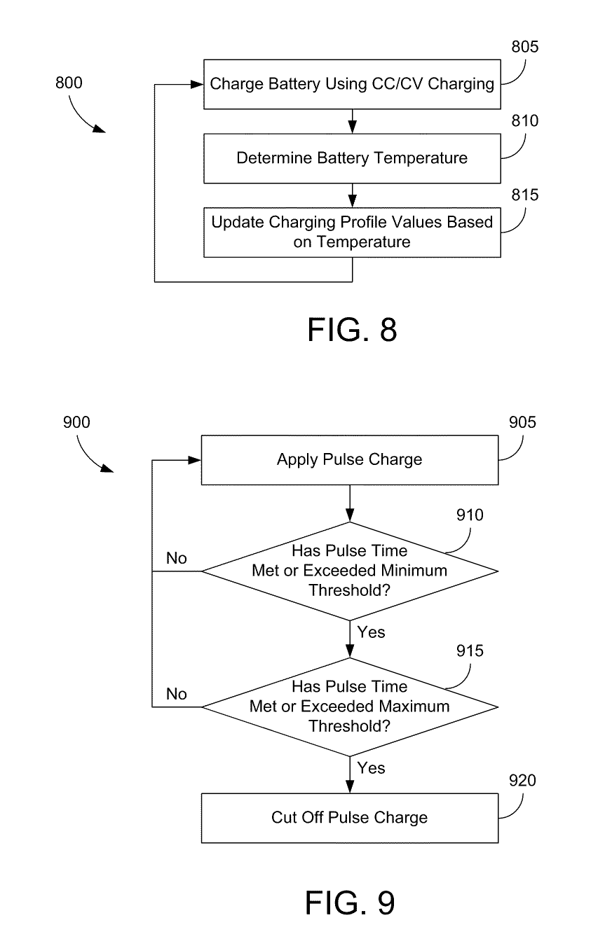

Referring now to FIG. 8, a process 800 for charging a zinc-air battery is shown according to an exemplary embodiment. The process 800 charges the battery using at least one charge profile that is adjusted based at least in part on the battery temperature. The current density and voltage are related to the battery temperature during charging.

The process 800 begins by charging the battery using any charging technique (e.g., CC or CV charging) (step 805). At step 810, the process 800 determines the temperature of the battery (e.g., from a temperature probe or sensor). At step 815, the process 800 adjusts a charge profile for the battery (e.g., a CC and/or CV charge profile) based on the determined temperature. In one embodiment, if the temperature of the battery during charging is 60 degrees Celsius, the cut off threshold for CV charging may be changed from 2.15 V to 2.11 V. The charge profiles may be adjusted for the temperature based on adjustment algorithms, data stored in a memory, etc.

Referring now to FIG. 9, a process 900 for charging a zinc-air battery is shown according to an exemplary embodiment. The process 900 charges the battery using pulse charging. Pulse charging may use high voltage and/or high current pulses to improve the charge rate of the battery. If the pulse duration is too long, there is an increased risk of dendrite formation, shape change, increased hydrogen formation and/or oxygen gas entrapment in the battery, potentially damaging the battery. If the pulse duration is too short, the rate of the electrochemical reactions may be too slow to cause a substantial increase in the rate of charge. According to one embodiment, the pulse duration may range from 1 second to 60 seconds. According to some embodiments, the voltage during the pulse should be less than 2.2 V and the current should be less than 200 mA/cm².

The process 900 begins by applying a pulse charge (step 905). At step 910, the process 900 determines whether the pulse duration has met or exceeded a minimum threshold. In one embodiment, the minimum threshold is 1 second. If the pulse duration has not met or exceeded the minimum threshold, the process 900 continues applying the pulse charge (step 905). If the pulse duration has met or exceeded the minimum threshold, the process 900 determines if the pulse time has met or exceeded a maximum threshold (step 915). In one embodiment, the maximum threshold is 60 seconds. If the pulse duration has not met or exceeded the maximum threshold, the process 900 may continue to apply the pulse charge (step 905). In some embodiments, the process 900 may cut off the pulse charge before it meets or exceeds the maximum threshold. If the pulse duration has met or exceeded the maximum threshold, the process 900 cuts off the pulse charge. One or more additional pulses may be subsequently applied (e.g., periodically).

In some embodiments, charge pulses (e.g., according to process 900) may be applied while charging the battery using a non-pulse method or profile and/or normal charging cycle. In some embodiments, a normal charging profile or cycle (e.g., using CC and/or CV charging and/or another type of charging) may be used to charge the battery, and one or more pulse charges may applied during the normal charging cycle (e.g., periodically, upon occurrence of a condition, etc.). In some embodiments, the time duration during which the pulses are being applied may be substantially shorter than the time duration in which the normal charging profile is applied during the charging cycle (e.g., one fifth, one tenth, one twentieth, one hundredth, etc. of the normal charging profile time). Pulse charges may be applied during a charging profile to extend the life of the battery and/or to reduce or reverse damage to the battery. For example, charge pulses may be applied upon detection of damage to a battery to reduce the damage, as discussed in further detail below. In some embodiments, charge pulses may be applied to a battery separately from a normal charging method for the battery (e.g., as part of a charging profile intended to reduce or reverse damage to the battery).

In various embodiments, the pulse charges may be applied in different ways. For example, in one embodiment, the battery may be initially charged at a first voltage and one or more charge pulses may be applied at a voltage higher than the first voltage. The voltage level at which the battery is charged may be returned to the first voltage level (or another voltage level lower than the pulse voltage level) after application of each pulse charge. In another embodiment, the battery may be initially charged at a first current and one or more charge pulses may be applied at a current higher than the first current. The current level at which the battery is charged may be returned to the first current level (or another current level lower than the pulse current level) after application of each pulse charge. In another embodiment, the battery may be initially charged at the first current and one or more charge pulses may be applied at a lower current (e.g., a reduced or substantially zero current) than the first current. The current level at which the battery is charged may be returned to the first current level (or another current level higher than the pulse current level) after application of each pulse charge. In yet another embodiment, the battery may be initially charged at the first current having a first direction and one or more charge pulses may be applied at a current having a direction opposite the first direction (i.e., a reverse current). The current at which the battery is charged may be returned to the first direction after application of each pulse charge.

Pulse charging may be used to repair the battery if the charger detects dU/dt or di/dt variations during charging before the targeted capacity is reached. For example, if during CC charging a sharp voltage drop is observed it may indicate the formation of micro shorts in the battery. A charge pulse (e.g., voltage or current) may be used to remove the micro shorts. If the pulse is too long the capacity may be reduced and the charge time of the battery may be increased. In one embodiment the pulse duration time may be 5 seconds. In some embodiments the pulse duration minimum threshold may be 1 second and the pulse duration maximum threshold may be 60 seconds. In various embodiments the voltage of the pulse should be less than 1.2 V and the current should be less than 200 mA/cm².

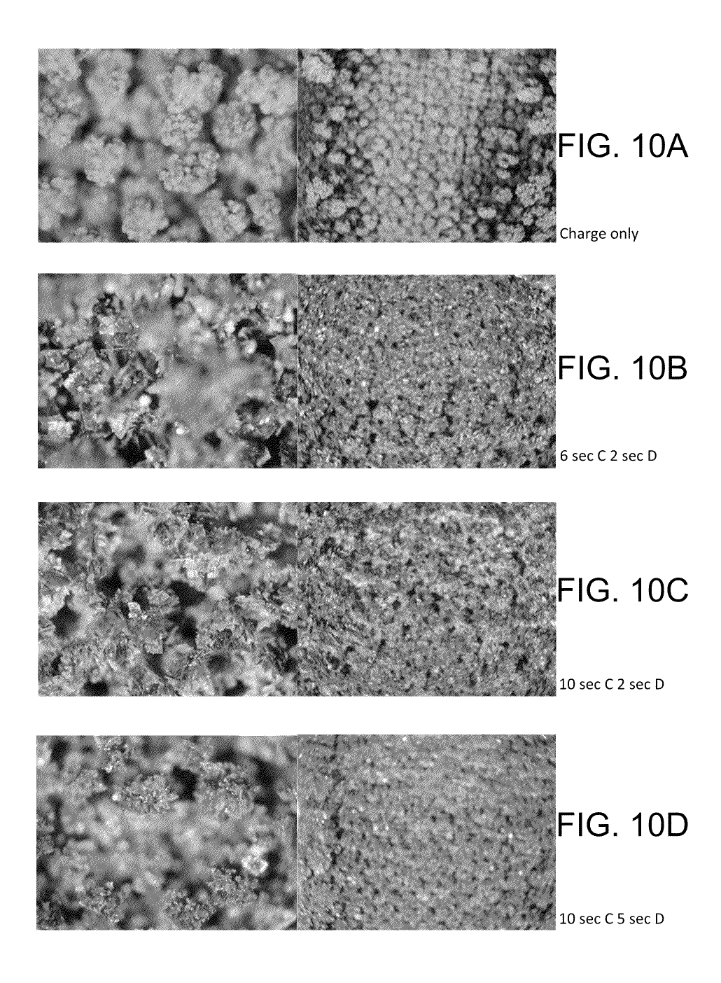

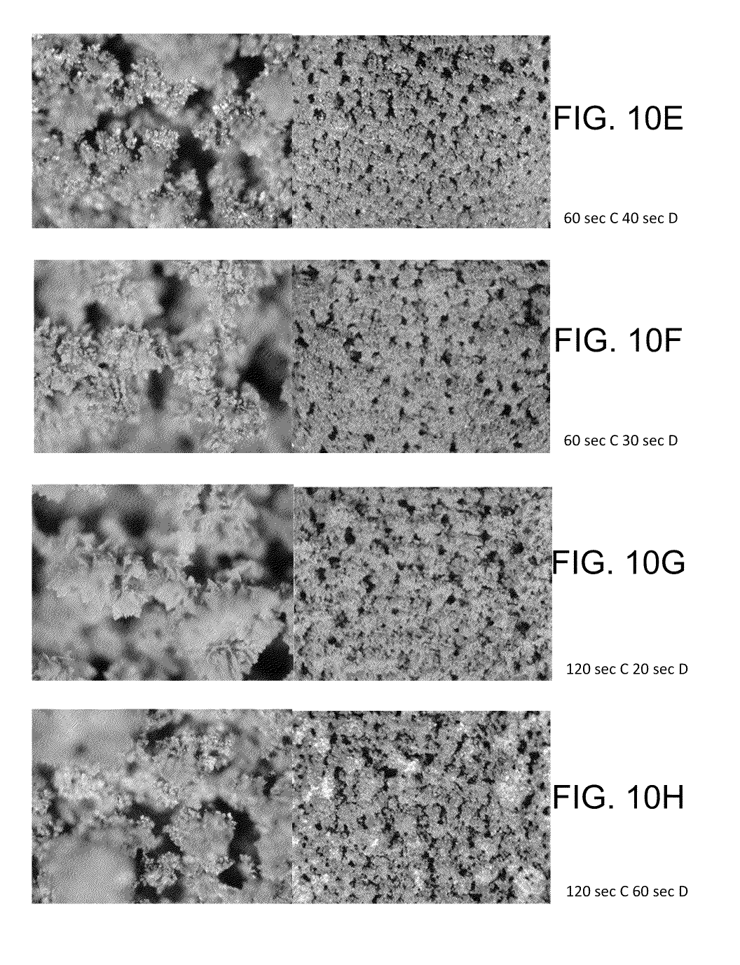

Referring now to FIGS. 10A through 10H, illustrations of the surface of zinc electrodes of a zinc-air battery after a series of charge and discharge pulses have been applied to the battery are shown according to an exemplary embodiment. FIGS. 10A through 10H display the surface of exemplary zinc electrodes prepared by applying a zinc paste onto a copper current collector. In the illustrated exemplary embodiments, the zinc paste used to prepare the electrodes included 2.7 g Zn powder, 0.2 g SnCa(OH)₂, 0.1 g Carbopol, and 0.1 g PTFE. The geometric surface area of the electrodes was 12 cm². Both the charge and discharge pulses were applied using a constant current of 1 A, or 83.3 mA/cm². Each of FIGS. 10A through 10H displays an image of a zinc electrode obtained by charging the electrode to its full capacity, removing the electrode, drying it, and inserting it into a microscope to obtain the image.

FIG. 10A illustrates the surface of a zinc electrode charged at a constant current of 83.3 mA/cm² until the electrode reached full capacity. FIG. 10B illustrates the surface of a zinc electrode charged using a six second charge pulse followed by a two second discharge pulse. In the exemplary embodiments shown in FIGS. 10B through 10H, the charge and discharge patterns were repeated until the zinc electrode was charged to full capacity. FIG. 10C illustrates the surface of a zinc electrode charged using a 10 second charge pulse followed by a two second discharge pulse. FIG. 10D illustrates the surface of a zinc electrode charged using a 10 second charge pulse followed by a five second discharge pulse. FIG. 10E illustrates the surface of a zinc electrode charged using a 60 second charge pulse followed by a 40 second discharge pulse. FIG. 10F illustrates the surface of a zinc electrode charged using a 60 second charge pulse followed by a 30 second discharge pulse. FIG. 10G illustrates the surface of a zinc electrode charged using a 120 second charge pulse followed by a 20 second discharge pulse. FIG. 10H illustrates the surface of a zinc electrode charged using a 120 second charge pulse followed by a 60 second discharge pulse. Comparison of the image shown in FIG. 10A with those shown in FIGS. 10B through 10H illustrates structural differences between the respective zinc electrodes, indicating that a discharge pulse may reduce unwanted zinc dendrite growth and shape changes.

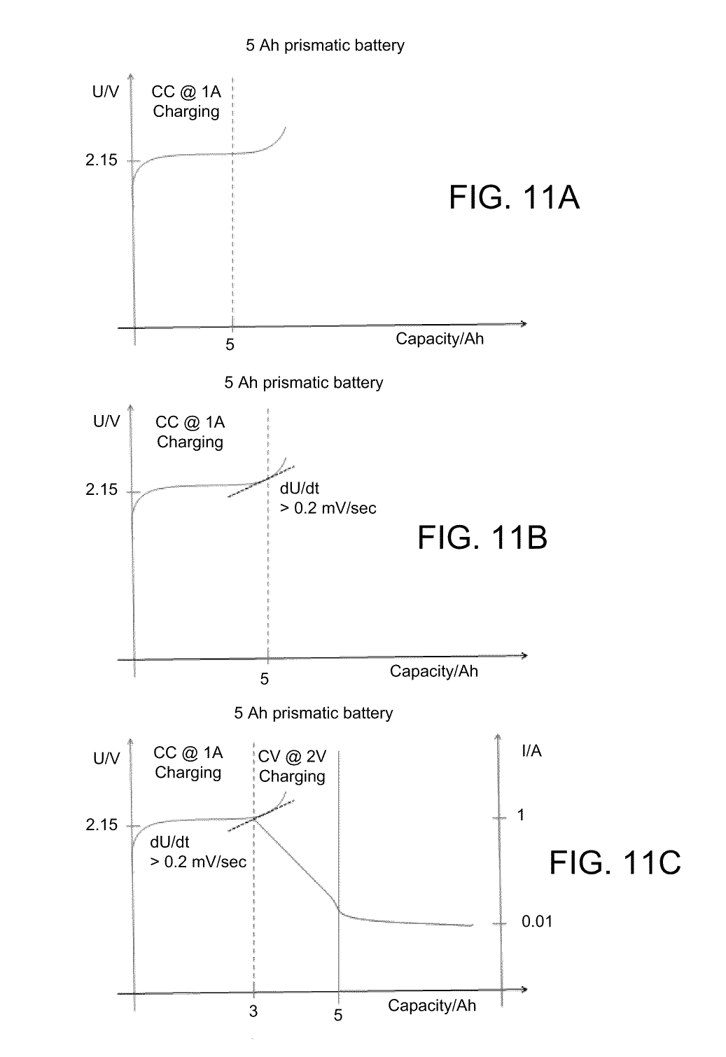

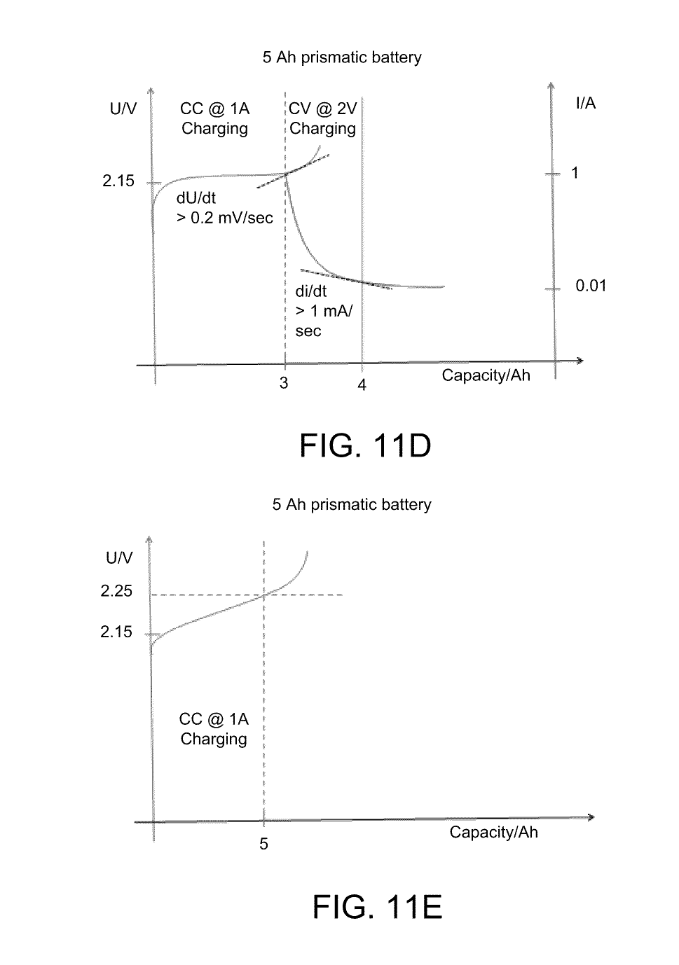

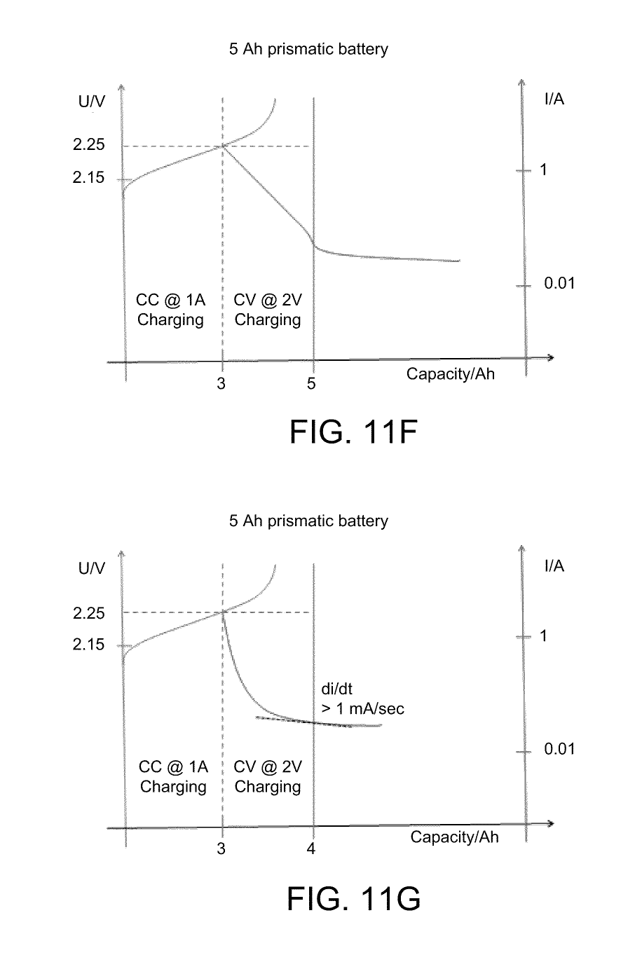

Referring now to FIGS. 11A through 11G, graphs illustrating charging profiles for zinc-air batteries are shown according to various exemplary embodiments. As is illustrated in FIGS. 11A through 11G, in various embodiments, the charging processes described herein may be used individually or in combination with other processes. The scope of the present disclosure includes any combination of one or more of the charging processes disclosed herein.

The graph of FIG. 11A illustrates a charging profile for which the critical point of the charging profile (i.e., where the voltage begins rapidly increasing near the right side of the curve) is greater than the target capacity (5 Ah) of the battery. The battery is charged using CC charging until the battery charge reaches the target capacity, at which point the charge is cut off based on the coulomb count (e.g., according to process 600).

The graph of FIG. 11B illustrates a charging profile for which the critical point matches the target capacity of the battery. The battery is charged using CC charging until the battery charge reaches the target capacity, at which point the charge is cut off based on the dU/dt exceeding 0.02 mV/sec (e.g., according to process 500).

The graph of FIG. 11C illustrates a charging profile for which the critical point (3 Ah) is lower than the target capacity of the battery. The battery is charged to 3 Ah using CC charging, at which point the CC charging is stopped due to dU/dt exceeding 0.02 mV/sec (e.g., according to process 500). At 3 Ah the battery begins charging using CV charging, which is cut off at the target capacity based on the coulomb count (e.g., according to process 600). In the exemplary embodiment illustrated in FIG. 11C, the portion of the charging profile to the left of the vertical dotted line intersecting the capacity axis at 3 Ah corresponds to CC charging and is provided with reference to the voltage (i.e., UN) vertical axis. The portion of the charging profile to the right of the vertical dotted line and below the diagonal dotted line labeled dU/dt>0.2 mV/sec corresponds to CV charging and is provided with reference to the current axis.

The graph of FIG. 11D illustrates a charging profile for which the critical point (3 Ah) is lower than the target capacity of the battery. The battery is charged to 3 Ah using CC charging, at which point the CC charging is stopped due to dU/dt exceeding 0.02 mV/sec (e.g., according to process 500). At 3 Ah the battery begins charging using CV charging, which is cut off at 4 Ah (less than the target capacity of 5 Ah) due to a di/dt of less than 1 mA/sec, indicating possible hydrogen formation (e.g., according to process 500). In the exemplary embodiment illustrated in FIG. 11D, the portion of the charging profile to the left of the vertical dotted line intersecting the capacity axis at 3 Ah corresponds to CC charging and is provided with reference to the voltage (i.e., UN) vertical axis. The portion of the charging profile to the right of the vertical dotted line and below the diagonal dotted line labeled dU/dt>0.2 mV/sec corresponds to CV charging and is provided with reference to the current axis.

The graph of FIG. 11E illustrates a charging profile for which the critical point is at the target capacity. The battery is charged using CC charging and is cut off at the target capacity due to the maximum voltage (2.25 V) being met (e.g., according to process 400).

The graph of FIG. 11F illustrates a charging profile for which the critical point (3 Ah) is lower than the target capacity of the battery. The battery is charged using CC charging to 3 Ah, at which point the CC charging is stopped due to meeting the maximum voltage (e.g., according to process 400). At 3 Ah the battery begins charging using CV charging, and CV charging is cut off at the target capacity based on the coulomb count (e.g., according to process 600). In the exemplary embodiment illustrated in FIG. 11F, the portion of the charging profile to the left of the vertical dotted line intersecting the capacity axis at 3 Ah corresponds to CC charging and is provided with reference to the voltage (i.e., UN) vertical axis. The portion of the charging profile to the right of the vertical dotted line and below horizontal dotted line indicating a voltage of 2.25 V on the voltage axis corresponds to CV charging and is provided with reference to the current axis.

The graph of FIG. 11G illustrates a charging profile for which the critical point (3 Ah) is lower than the target capacity of the battery. The battery is charged using CC charging to 3 Ah, at which point the CC charging is stopped due to meeting the maximum voltage (e.g., according to process 400). At 3 Ah the battery begins charging using CV charging, and CV charging is cut off at 4 Ah (below the target capacity) due to a di/dt of less than 1 mA/sec, indicating possible hydrogen formation (e.g., according to process 500). In the exemplary embodiment illustrated in FIG. 11G, the portion of the charging profile to the left of the vertical dotted line intersecting the capacity axis at 3 Ah corresponds to CC charging and is provided with reference to the voltage (i.e., UN) vertical axis. The portion of the charging profile to the right of the vertical dotted line and below horizontal dotted line indicating a voltage of 2.25 V on the voltage axis corresponds to CV charging and is provided with reference to the current axis.

The processes above may be implemented using hardware and/or software included in the battery charger, electronics for the battery, or elsewhere. In some embodiments, a zinc-air battery may have an open circuit voltage of 1.4 V. For some applications (e.g., where a lithium ion battery is used) a different nominal voltage (e.g., 3.7 V) may be needed. Various embodiments may make use of a DC/DC converter (e.g., unidirectional or bidirectional). In some embodiments, a the battery and/or charger electronics may include a capacitor configured to buffer the voltage peeks during discharge. This may help increase the capacity of the battery.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the zinc-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure.

The present disclosure contemplates methods, systems and program products on any machine-readable media for accomplishing various operations. The embodiments of the present disclosure may be implemented using existing integrated circuits, computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. In various embodiments, more, less or different steps may be utilized with regard to a particular method without departing from the scope of the present disclosure. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method of charging a metal-air battery, the method comprising:
charging the metal-air battery using a charge profile;
applying a pulse charge to the metal-air battery; and
returning to charging the metal-air battery using the charge profile after the pulse charge has been applied.

2. The method of claim 1, wherein applying the pulse charge comprises:
detecting that a pulse time of the pulse charge has exceeded a minimum pulse time threshold; and
stopping the pulse charge after the pulse time has exceeded the minimum pulse time threshold and before the pulse time exceeds a maximum pulse time threshold.

3. The method of claim 2, wherein the minimum pulse time threshold is 1 second and the maximum pulse time threshold is 60 seconds.

4. The method of claim 1, wherein charging the metal-air battery using a charge profile comprises charging the metal-air battery at a first voltage, and wherein applying the pulse charge comprises charging the metal-air battery at a second voltage that is higher than the first voltage.

5. The method of claim 1, wherein charging the metal-air battery using a charge profile comprises charging the metal-air battery at a first current, and wherein applying the pulse charge comprises charging the metal-air battery at a second current that is higher than the first current.

6. The method of claim 1, wherein charging the metal-air battery using a charge profile comprises charging the metal-air battery at a first current, and wherein applying the pulse charge comprises charging the metal-air battery at a second current that is lower than the first current.

7. The method of claim 1, wherein charging the metal-air battery using a charge profile comprises charging the metal-air battery at a first current having a first direction, and wherein applying the pulse charge comprises charging the metal-air battery at a second current having a second direction that is opposite the first direction.

8. The method of claim 1, wherein said charging, applying and returning are performed in a single charge cycle having a cycle duration, wherein a first portion of the cycle duration in which the pulse charge is applied is substantially shorter in duration than a second portion of the cycle duration in which the metal-air battery is charged using the charge profile.

9. The method of claim 8, further comprising applying a plurality of pulse charges during the single charge cycle, wherein a total duration of the plurality of pulse charges is substantially shorter in duration than the second portion of the cycle duration in which the metal-air battery is charged using the charge profile.

10. The method of claim 1, wherein the pulse charge is a voltage pulse charge.

11. The method of claim 10, wherein a voltage of the voltage pulse charge is less than 2.2 V.

12. The method of claim 1, wherein the pulse charge is a current pulse charge.

13. The method of claim 12, wherein a current of the current pulse charge is less than 200 mA/cm².

14. The method of claim 1, wherein applying a pulse charge to the metal-air battery comprises:
while charging a metal-air battery, detecting damage to the metal-air battery by detecting a variation in at least one of a rate of change of a voltage of the metal-air battery or a rate of change of a current of a metal-air battery before a charge capacity of the metal-air battery is reached; and
applying the pulse charge to the metal-air battery in response to detecting the damage.

15. An apparatus for charging a metal-air battery, the apparatus comprising:
a battery charger configured to charge the metal-air battery, wherein the battery charger is configured to:
charge the metal-air battery using a charge profile;
apply a pulse charge to the metal-air battery; and
return to charging the metal-air battery using the charge profile after the pulse charge has been applied.

16. The apparatus of claim 15, wherein the battery charger is configured to apply the pulse charge by:
detecting that a pulse time of the pulse charge has exceeded a minimum pulse time threshold; and
stopping the pulse charge after the pulse time has exceeded the minimum pulse time threshold and before the pulse time exceeds a maximum pulse time threshold.

17. The apparatus of claim 16, wherein the minimum pulse time threshold is 1 second and the maximum pulse time threshold is 60 seconds.

18. The apparatus of claim 15, wherein the battery charger is configured to:
charge the metal-air battery using the charge profile at a first voltage; and
apply the pulse charge at a second current that is higher than the first voltage.

19. The apparatus of claim 15, wherein the battery charger is configured to:
charge the metal-air battery using the charge profile at a first current; and
apply the pulse charge at a second current that is higher than the first current.

20. The apparatus of claim 15, wherein the battery charger is configured to:
charge the metal-air battery using the charge profile at a first current; and
apply the pulse charge at a second current that is lower than the first current.

21. The apparatus of claim 15, wherein the battery charger is configured to:
charge the metal-air battery using the charge profile at a first current having a first direction; and
apply the pulse charge at a second current having a second direction that is opposite the first direction.

22. The apparatus of claim 15, wherein the battery charger is configured to perform said charging, applying and returning in a single charge cycle having a cycle duration, wherein a first portion of the cycle duration in which the pulse charge is applied is substantially shorter in duration than a second portion of the cycle duration in which the metal-air battery is charged using the charge profile.

23. The apparatus of claim 22, wherein the battery charger is configured to apply a plurality of pulse charges during the single charge cycle, wherein a total duration of the plurality of pulse charges is substantially shorter in duration than the second portion of the cycle duration in which the metal-air battery is charged using the charge profile.

24. The apparatus of claim 15, wherein the pulse charge is a voltage pulse charge.

25. The apparatus of claim 24, wherein a voltage of the voltage pulse charge is less than 2.2 V.

26. The apparatus of claim 15, wherein the pulse charge is a current pulse charge.

27. The apparatus of claim 26, wherein a current of the current pulse charge is less than 200 mA/cm².

28. The apparatus of claim 15, wherein the battery charger is configured to, while charging the metal-air battery, detect damage to the metal-air battery by detecting a variation in at least one of a rate of change of a voltage of the metal-air battery or a rate of change of a current of a metal-air battery before a charge capacity of the metal-air battery is reached, and wherein the battery charger is configured to apply the pulse charge to the metal-air battery in response to detecting the damage.

29. A method of charging a metal-air battery, the method comprising:
while charging a metal-air battery using a charge profile, detecting damage to the metal-air battery by detecting a variation in at least one of a rate of change of a voltage of the metal-air battery or a rate of change of a current of a metal-air battery before a charge capacity of the metal-air battery is reached; and
applying a pulse charge to the metal-air battery to reduce the damage.

30. The method of claim 29, wherein detecting damage to the metal-air battery comprises detecting a short in the metal-air battery by identifying a drop in voltage while charging using a constant current, wherein the pulse charge is applied to remove the short.

31. The method of claim 29, wherein charging the metal-air battery comprises charging the metal-air battery at a first voltage, and wherein applying the pulse charge comprises charging the metal-air battery at a second voltage that is higher than the first voltage.

32. The method of claim 29, wherein charging the metal-air battery comprises charging the metal-air battery at a first current, and wherein applying the pulse charge comprises charging the metal-air battery at a second current that is higher than the first current.

33. The method of claim 29, wherein charging the metal-air battery comprises charging the metal-air battery at a first current, and wherein applying the pulse charge comprises charging the metal-air battery at a second current that is lower than the first current.

34. The method of claim 29, wherein charging the metal-air battery comprises charging the metal-air battery at a first current having a first direction, and wherein applying the pulse charge comprises charging the metal-air battery at a second current having a second direction that is opposite the first direction.

35. The method of claim 34, wherein said charging, detecting and applying are performed in a single charge cycle having a cycle duration, wherein a first portion of the cycle duration in which the pulse charge is applied is substantially shorter in duration than a second portion of the cycle duration in which the metal-air battery is charged using the charge profile.

36. The method of claim 35, further comprising applying a plurality of pulse charges during the single charge cycle, wherein a total duration of the plurality of pulse charges is substantially shorter in duration than the second portion of the cycle duration in which the metal-air battery is charged using the charge profile.

37. The method of claim 29, wherein applying the pulse charge comprises:
detecting that a pulse time of the pulse charge has exceeded a minimum pulse time threshold; and
stopping the pulse charge after the pulse time has exceeded the minimum pulse time threshold and before the pulse time exceeds a maximum pulse time threshold.

38. The method of claim 37, wherein the minimum pulse time threshold is 1 second and the maximum pulse time threshold is 60 seconds.

39. The method of claim 29, wherein the pulse charge is a voltage pulse charge.

40. The method of claim 39, wherein a voltage of the voltage pulse charge is less than 2.2 V.

41. The method of claim 29, wherein the pulse charge is a current pulse charge.

42. The method of claim 41, wherein a current of the current pulse charge is less than 200 mA/cm².
